(19) United States
(12) Patent Application Publication
(10) Pub. No.: US 2008/0127175 A1
(43) Pub. Date: May 29, 2008

(54) Packaging software products as single-file executables containing scripting logic

(75) Inventors: Ivan Naranjo, Redmond, WA (US); J. Anthony East, Redmond, WA (US); Scott T. Mantei, Redmond, WA (US); Jeffrey M. James, Kirkland, WA (US); Thomas J. Donchess, Poulsbo, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/590,979

(22) Filed: Nov. 1, 2006

(51) Int. Cl. G06F 9/445

(52) U.S. Cl. 717/174

(57) ABSTRACT

A packaging tool is provided for creating a single self-extracting executable file from individual installation files of a software program and an installation script that flexibly performs pre-installation checks, installs the software product, and performs any post-installation operations. Scripted actions in the installation executable are designed according to a schema such that dialogs, actions, and execution are customizable and extensible. Chaining and sequencing of update patches may be accomplished through the scripted actions. The script may be prepared to verify system requirements, qualifying products for updates, language(s), platform, and the like. The executable may also query component information from existing system. By providing customizable and extensible installation operations in a single executable file, updates and new product installations are made easier for distribution through downloading as well as through portable media.

### BACKGROUND

Distribution of software products and updates occurs increasingly over public and private networks such as the worldwide web. Using conventional distribution method such as CD-ROMs, software products and updates are distributed as multiple installation files (typically in multiple directories). However, downloading over a network is optimally accomplished via a single file download. This ensures that a single successful file download transaction does translate to a successful product or update download transaction.

Some of the single file distribution solutions may have inherent limitations. Self extracting executable packagers may include limitations such as package creation restrictions, single language per package, and the like, which may result in user dissatisfaction. Other distribution solutions may include retrieving an “ISO image” of the installation media, which while providing a single file download, typically necessitates additional user actions (e.g. obtaining a ISO image to disk burning utility). These additional actions may exceed a mainstream user's technical understanding and capability.

Additionally, it may be desirable to control the distribution and re-distribution of the software products for the software manufacturers by ensuring that the end user has met certain pre-requisites such as Eula acceptance, qualifying product, hardware requirements, and the like.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to creating a single self-extracting executable file from individual installation files and an installation script that flexibly accomplishes pre-requisite checks, installs the software product, and performs any post-installation operations. According to some embodiments, the script may be prepared to verify system requirements, qualifying products for updates, language(s), platform, and the like. Scripted actions in the installation executable may be designed according to a schema such that dialogs, actions, and execution are customizable and extensible. Scripted actions may accomplish chaining and sequencing of update patches.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates a conceptual diagram of an installation executable distribution according to embodiments;

FIG. 2 illustrates a diagram of an example creation of an installation executable;

FIG. 3 illustrates an example installation process using a scripted installation executable according to embodiments;

FIG. 4 illustrates use distribution of an installation executable in a networked system;

FIG. 5 is a block diagram of an example computing operating environment, where embodiments may be implemented; and

FIG. 6 illustrates a logic flow diagram for a process of creating and using a scripted installation executable according to embodiments.

### DETAILED DESCRIPTION

As briefly described above, a packaging tool according to embodiments creates a single self-extracting executable file from individual installation files and an installation script that performs pre-installation checks, installs the software product, and performs any post-installation operations. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

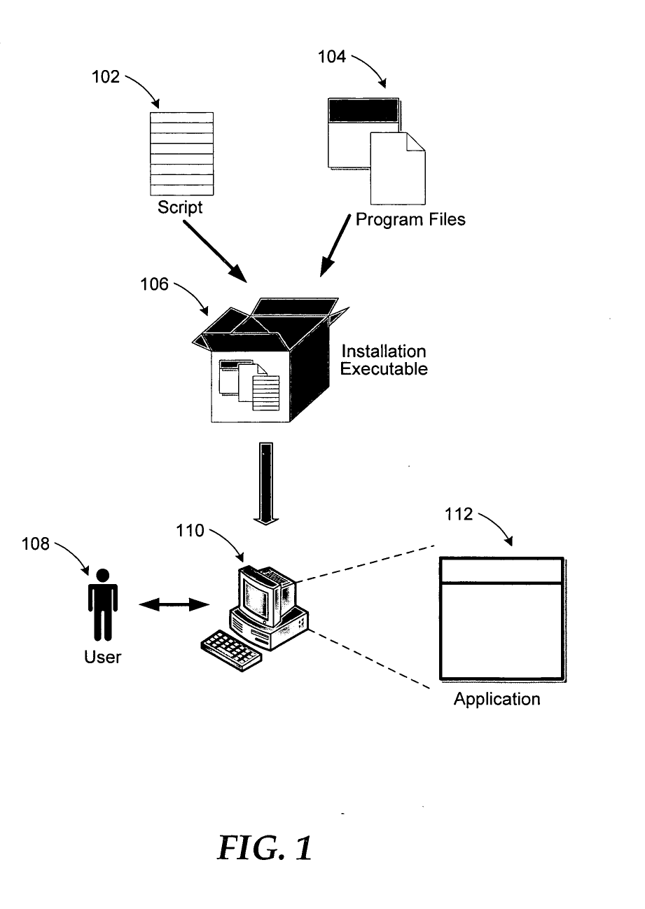

Referring to FIG. 1, a conceptual diagram of an installation executable distribution according to embodiments is illustrated. As mentioned previously, downloading of products over a network is optimally accomplished via a single file download. This ensures that a single successful file download transaction does translate to a successful product or update download transaction. Furthermore, a scripted installation executable may allow customizable and extensible sequencing of installation operations. A packaging tool according to embodiments creates a single self-extracting executable file from individual installation files and an installation script that flexibly accomplishes the pre-requisite checks, installs the software product, and performs any post-installation operations.

Typically, installation files for a software product or an update include a number of data files, DLLs, and other types of files. In some cases, these may be organized in a plurality of directories. In addition to potential downloading problems, dealing with multiple files increases risks of unauthorized use (e.g. individual files may be easier to tamper with) and limits customizability of installation processes.

As shown in FIG. 1, program files 104 may include a number of different types of files. Script file 102 may be generated in a structured language such as Extensible Markup Language (XML) such that actions associated with the installation are sequenced and/or chained according to a predefined policy. The script according to a schema may allow use of alternative dialogs, languages, and other installation options. Script file (102) and program files 104 may be combined into installation executable 106 for a compact, downloadable method of distribution. Installation executable 106 may be distributed in various ways to the users (e.g. user 108) such as using portable media or by downloading over public or private networks.

Once loaded onto a computing device such as desktop computer 110, the installation executable may be executed, where the script controls the execution of individual actions interacting with user 108, performing pre-installation checks, copying and/or expanding program files, configuring and/or registering components, and the like. Post-installation tasks such as activating installed application 112, deleting unnecessary files, and the like.

As mentioned above, the schema defining the installation script may be in XML format. However, embodiments are not limited to the XML programming languages and formats. Packaging software products in a single executable file containing scripting logic may be implemented in any language, format, and structure using the principles described herein.

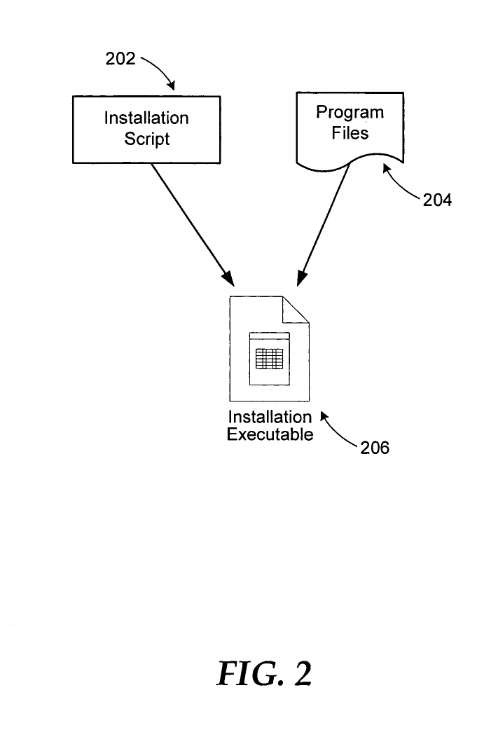

FIG. 2 illustrates a diagram of an example creation of an installation executable. At the core of a single-file installation system according to embodiments is the installation script 202. The script defines a behavior for the installation package as a list of actions to be performed in a specific order. The actions, in turn, control interactions with the user through dialogs, perform pre-installation checks, query and configure system components, and install program files.

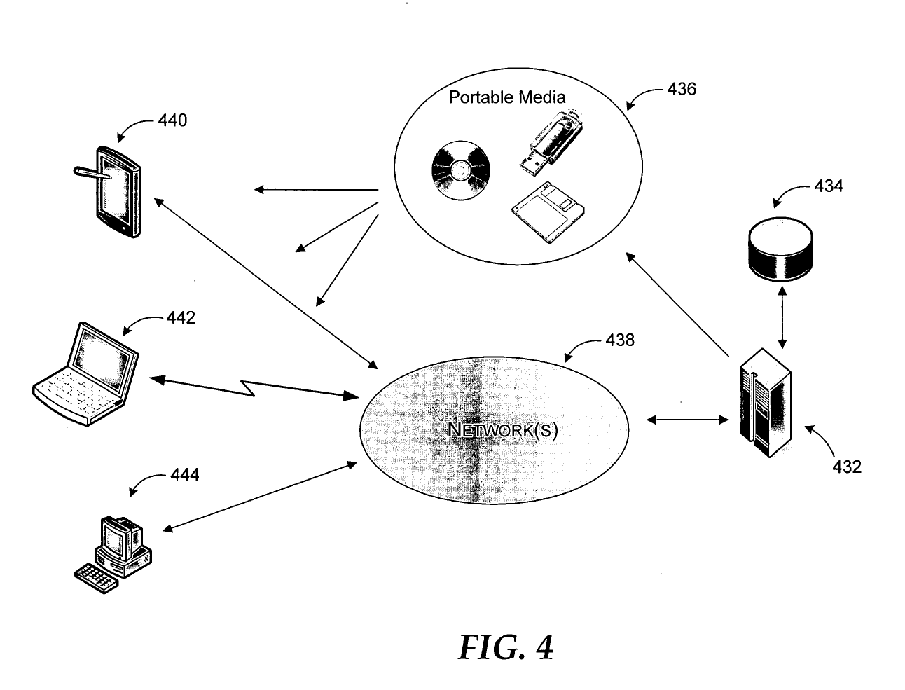

In generating the installation executable 206, the program files 204 and installation script 202 are combined into a single file. The installation executable may be compressed or otherwise processed for distribution in any way known in the art. Security measures, such as password protection, may also be integrated into the installation executable 206. The installation executable 206 is then distributed to the users through various methods such as those described in conjunction with FIG. 4.

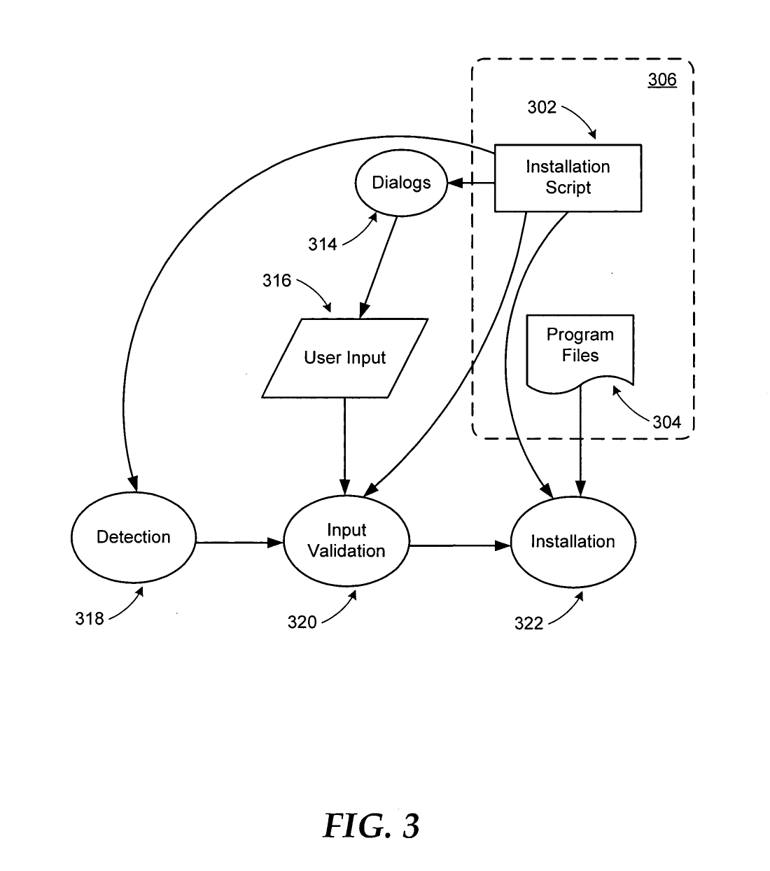

FIG. 3 illustrates an example installation process using a scripted installation executable according to embodiments. The executable (306) controls installation operations through a series of actions defined in installation script 302.

Installation executable 306, according to embodiments, conforms to an extensibility model where it is able to load Dynamic Link Libraries (DLLs) and is able to call into functions with a specific signature, thus allowing the addition of new features that cannot just be “coded” using the XML language. This way, the UI experience may be changed without affecting a package behavior.

The behavior for the package may be defined in an XML file as a list of actions to be performed in a specific order. This order may be defined by the order of the elements in the XML file. Each of these actions may be defined as an <Action> element with a type attribute that defines what kind of action is called. An example piece of code is provided below:

```
<Action type=“YesNoPrompt”>
    <Title>$(TEST.TITLE)</Title>
    <Text>This script will test the file actions, do you want to
    continue</Text>
    <Button type=“No”>
        <Action type=“Quit” />
    </Button>
</Action>
```

The action described above is an action of type YesNoPrompt, which when executed by the interpreter prompts the user with a YES/NO message box. The example code also shows that each action element may contain all of the information required to execute it. In this case, the action contains the text for the title, the $(TEST.TITLE) is a reference to a property, the text for the prompt and what to do if the user presses the button NO.

Installation executable 306 performs multiple tasks once it is executed. These tasks may include detection, user interaction, installation, and post-installation tasks. Detection may include determination of environmental parameters such as system capabilities (processor speed, available memory and hard disk space, and the like), existing product(s) and/or product qualification, version(s) of existing components, language, user preferences (e.g. currency, date and time, and the like).

In an update scenario, the executable may detect if a patch or update is needed by or applicable to the system before doing so. The script may be set up such that the executable may be run in a “detection” mode to determine whether the patch is needed or not, but not install the patch. This mode provides users a simple way of knowing if the patch is needed, installed or not applicable. Once the script determines the applicability of the update, pre-requisite installation criteria may be checked prior to installing the payload. This check may include, but is not limited to, qualifying product(s), preferred language, operating system and/or platform, and required baseline updates. In some cases, an order of updates may be critical for the program. The script may determine which updates are already installed and install any additional ones according to the prescribed order. If there are time limitations on a patch such as an expiration date, the script may determine that and propose to the user to download and install a different patch. The users may also be directed to a download center, where they can download the package themselves.

The use of a schema-based script for describing the actions enables custom dialogs, actions, and custom execution of the actions. Thus, a developer may easily modify the installation executable by changing the installation script 302 and customizing the installation package for a particular purpose. Installation script 302 also provides the ability to create a universal package applicable to any language. Each package may contain language resources for as many languages as necessary.

In the case of update packaging, part of the payload of the update package may be update metadata for consumption by end users and other systems. For example, the XML schema-based script and delivery method may be employed to keep an inventory of the patches in a database.

According to some embodiments, additional installation and post-installation tasks controlled by the installation script 302 may include transmission of failure reports to a monitoring center, activation of components, querying of system resources to gather information regarding existing components and registry operations. A time-sensitive limitation may even be included such that the script may check a download center for current updates if a pre-defined deadline for installing the product has expired. According to other embodiments, installation script 302 may also include rules that define constraints on installation parameters such as which components are to be installed for a given language or user ID.

In an operation, installation script 302 initiates the installation process with the detection actions 318 as described above. Once sufficient information is gathered the script interacts with the user by prompting dialogs 314 and receiving user input 316. The information provided by the user, such as a product key number, user name, and the like, may then be validated in a input validation operation 320. The installation operations 322, such as copying of program files 304, configuration and registration of components, and the like, follow the input validation 320. In some embodiments, post-installation operations such as those described above may also be performed upon successful completion of installation operations 322.

Embodiments are not limited to the illustrated examples operations and components in FIG. 1 through FIG. 2. Other architectures may be implemented using the principles described herein for a software installation packaging system using single-file executables containing scripting logic.

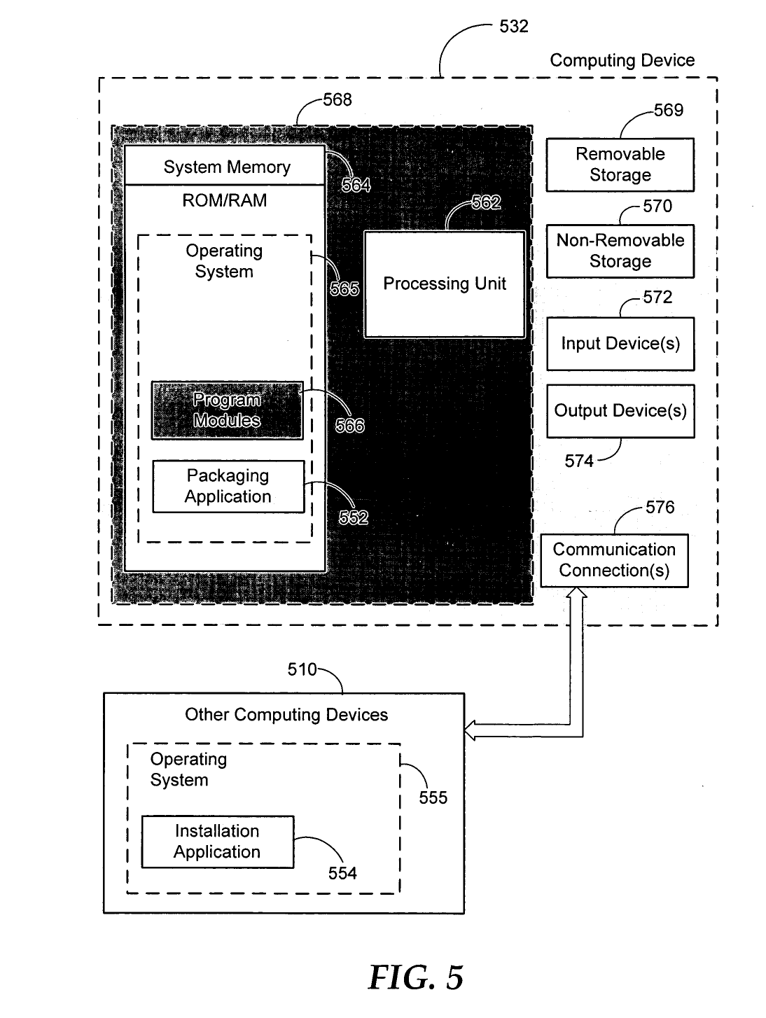

Referring now to the following figures, aspects and exemplary operating environments will be described. FIG. 4, FIG. 5, and the associated discussion are intended to provide a brief, general description of a suitable computing environment in which embodiments may be implemented.

FIG. 4 illustrates use distribution of an installation executable in a networked system. The system may comprise any topology of servers, clients, Internet service providers, and communication media. Also, the system may have a static or dynamic topology. The term “client” may refer to a client application or a client device employed by a user to perform operations associated with installing a software product. While a networked product installation file distribution system may include many more components, relevant ones are discussed in conjunction with this figure.

In a typical operation according to embodiments, server 432 executes one or more applications that prepare an installation script for a software product, retrieve program files associated with installing the software product from data store 434, and combine the script and the program files into a single-file installation executable. The single-file executable may then be distributed to users through one or more networks 438 or using portable storage media. Portable storage media may include any method of storing and distributing files such as CD-ROMs, floppy disks, flash drives, and others.

Server 438 may include additional programs with various functionalities associated with the installation of the software product such as an error monitoring program, a current update download program, and the like. These functionalities and similar ones may also be provided by other servers. As mentioned previously, distribution of software products by downloading over networks is becoming increasingly common. Commonly, there are two primary online software distribution scenarios. The first scenario is distribution of complete software programs, which is occurring with increasing frequency over networks. The second and more common scenario is distribution of product updates (e.g. security updates, functional patches, and the like) over the networks.

Network(s) 438 may include a secure network such as an enterprise network, an unsecure network such as a wireless open network, or the Internet. Network(s) 438 provide communication between the nodes described herein. By way of example, and not limitation, network(s) 438 may include wired media such as a wired network or direct-wired connection, and wireless media such as acoustic, RF, infrared and other wireless media.

Once distributed, the installation executable may be activated in any computing device including, but not limited to, the example devices of Personal Digital Assistant (PDA) 440, laptop computer 442, and desktop computer 444.

Many other configurations of computing devices, applications, data sources, data distribution and analysis systems may be employed to implement distribution of a software product using single-file executables containing scripting logic. Furthermore, the networked environments discussed in FIG. 4 are for illustration purposes only. Embodiments are not limited to the example applications, modules, or processes. A networked environment for using an installation executable with an installation script and program files may be provided in many other ways using the principles described herein.

With reference to FIG. 5, a block diagram of an example computing operating environment is illustrated, such as computing device 532. In a basic configuration, the computing device 532 typically includes at least one processing unit 562 and system memory 564. Computing device 532 may include a plurality of processing units that cooperate in executing programs. Depending on the exact configuration and type of computing device, the system memory 564 may be volatile (such as RAM), non-volatile (such as ROM, flash memory, etc.) or some combination of the two. System memory 564 typically includes an operating system 565 suitable for controlling the operation of a networked personal computer, such as the WINDOWS® operating systems from MICROSOFT CORPORATION of Redmond, Wash. The system memory 564 may also include one or more software applications such as program modules 566 and packaging application 552.

As described previously in more detail, packaging application 552 manages the creation of the installation script for controlling the installation of a software product and/or its updates and combines the installation script with applicable program files for installing the product (or updates). Packaging application 552, and any other related programs may be an integrated part of a distribution application or operate remotely and communicate with the distribution application and with other applications running on computing device 532 or on other devices. Furthermore, packaging application 552 may be executed in an operating system other than operating system 565. This basic configuration is illustrated in FIG. 5 by those components within dashed line 568.

The computing device 532 may have additional features or functionality. For example, the computing device 532 may also include additional data storage devices (removable and/or non-removable) such as, for example, magnetic disks, optical disks, or tape. Such additional storage is illustrated in FIG. 5 by removable storage 569 and non-removable storage 570. Computer storage media may include volatile and nonvolatile, removable and non-removable media implemented in any method or technology for storage of information, such as computer readable instructions, data structures, program modules, or other data. System memory 564, removable storage 569 and non-removable storage 570 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 532. Any such computer storage media may be part of device 532. Computing device 532 may also have input device(s) 572 such as keyboard, mouse, pen, voice input device, touch input device, etc. Output device(s) 574 such as a display, speakers, printer, etc. may also be included. These devices are well known in the art and need not be discussed at length here.

The computing device 532 may also contain communication connections 576 that allow the device to communicate with other computing devices 510, such as over a network in a distributed computing environment, for example, an intranet or the Internet. Communication connection 576 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

As described in detail previously, the installation executable created by packaging application 552 may be distributed through communication connections 576 to other computing devices 510, where it may be executed as installation application 506 within operating system 555. Operating systems 565 and 555 do not necessarily have to be the same.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

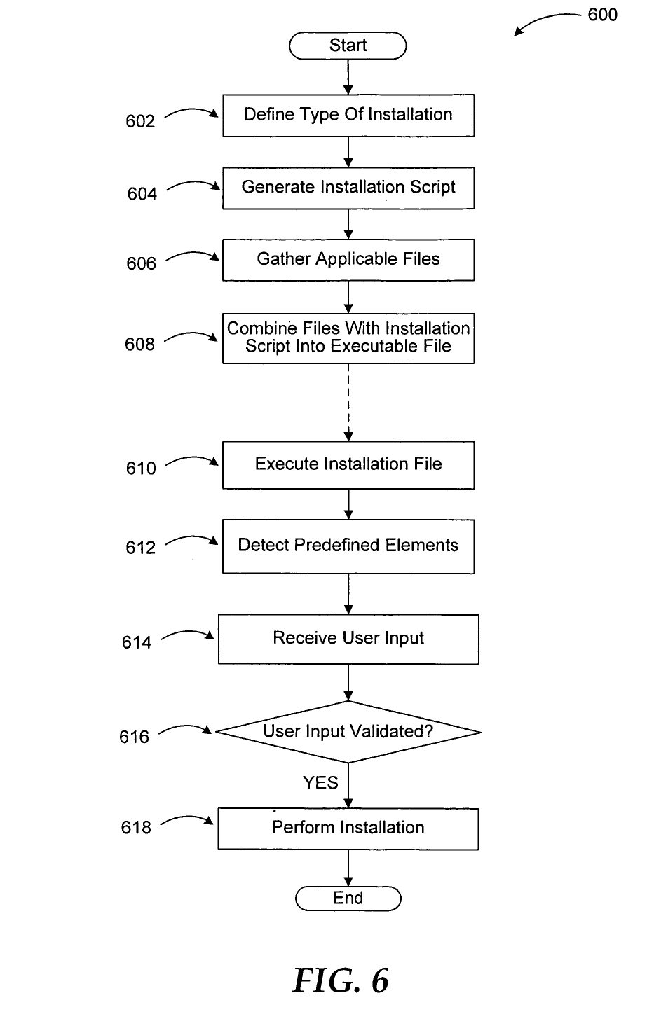

FIG. 6 illustrates a logic flow diagram for a process of creating and using a scripted installation executable. Parts of process 600 may be implemented in a packaging application, an installation executable, and the like.

Process 600 begins with operation 602, where a type of installation is defined. The type of installation, whether a new product installation or an update/patch installation may determine how an installation script is to be generated and an order of installation operations. Processing advances from operation 602 to operation 604.

At operation 604, the installation script is generated defining the actions and the order of actions for the installation tasks. The schema-based script may be generated using a structured language such as XML and is customizable and extensible. Processing proceeds from operation 604 to operation 606.

At operation 606, applicable program files are gathered. For each type of installation different sets of files including data files, DLLs, and the like may be necessary. Processing moves from operation 606 to operation 608.

At operation 608, the gathered program files and the installation script are combined into a single-file installation executable that can be downloaded over a network or distributed on a portable storage medium. Following operation 608, the installation executable is distributed to the users. A second portion of the process begins when a user executes the installation file. This gap in the operations is represented in process 600 with a dashed line.

At operation 610, the installation file is executed on a user computer. The execution activates the installation script, which begins performing the tasks in a predefined order. Processing advances from operation 610 to operation 612.

At operation 612, predefined elements such as system capacity (memory, hard disk space, etc.), existing software components, and the like are detected. Based on the detection results, the installation script may prompt the user to provide input such as selections, product key, user information, and the like. Processing advances from operation 612 to operation 614.

At operation 614, user input in response to the script prompted dialog(s) are received. The dialogs and a UI for the user to provide input may be customized by the script based on a type of installation, a system environment, and the like. Processing advances from operation 614 to decision operation 616.

At decision operation 616, a determination is made whether part or all of the user input is valid. If the user input is valid, processing advances from decision operation 616 to operation 618.

At operation 618, the installation tasks including, but not limited to, copying of files, activation of components, registration of components, and the like, are performed. After operation 616, processing moves to a calling process for further actions.

The operations included in process 600 are for illustration purposes. Packaging software products as single-file executables containing scripting logic may be implemented by similar processes with fewer or additional steps, as well as in different order of operations using the principles described herein. For example, additional post-installation tasks such as deletion of data files may be performed under the management of the installation script.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for installing a software product using a single executable file, the method comprising:
generating an installation script for managing installation operations;
if the installation operations are associated with a program file, combining the installation script with the program file associated with the installation operations;
generating the single executable file that includes the combined installation script and the program file; and
distributing the single executable file.

2. The method of claim 1, wherein the installation script is generated based on a type of installation.

3. The method of claim 1, wherein upon execution of the single executable file the installation script is configured to:
detect a system parameter associated with a user computing device;
prompt a dialog to receive a user input for a script parameter;
receive the user input; and
perform predefined actions associated with the installation operations based on the detected system parameter and the received user input.

4. The method of claim 3, wherein upon execution of the single executable file the installation script is further configured to:
determine an error in response to an action not being performed properly;
prompt a dialog to provide the user a feedback; and
report the error to a predefined monitoring application.

5. The method of claim 3, wherein upon execution of the single executable file the installation script is further configured to:
detect an existing software product component, if the installation is for an update; and
determine whether the existing component is eligible for the update.

6. The method of claim 3, wherein upon execution of the single executable file the installation script is further configured to:
perform post-installation actions that include at least one from a set of: registering the software product, deleting temporarily created files, and activating at least one component of the software product.

7. The method of claim 1, wherein the installation operations include at least one from a set of: creating one or more directories, copying files, decompressing files, configuring system parameters, and registering components of the software product with a user operating system.

8. The method of claim 1, wherein the installation script is schema-based and is configured to call a plug-in module for performing custom installation actions.

9. The method of claim 8, further comprising:
providing at least one installation script parameter to the plug-in module;
coordinating the custom installation actions performed by the plug-in with a flow of actions defined within the installation script.

10. The method of claim 1, wherein distributing the single executable file includes making the file available for downloading through at least one of: a private network and a public network.

11. The method of claim 1, wherein distributing the single executable file includes providing the file on a computer readable storage medium.

12. A computer-readable medium having computer executable instructions for installing a software product using a single executable file, the instructions comprising:
generating an installation script for managing installation operations based on a type of installation;
if the installation operations are associated with a program file, combining the installation script with the program file associated with the installation operations;
generating the single executable file that includes the combined installation script and the program file; and
distributing the single executable file by at least one of: making the single executable file available for downloading through a network and providing the file on a computer readable storage medium.

13. The computer-readable medium of claim 12, wherein the installation script includes a plurality of sequenced actions that are arranged to perform installation operations including at least one of: detecting a system parameter, prompting a user to provide input, validating the user input, copying files, decompressing files, configuring system parameters, and registering components of the software product with a user operating system.

14. The computer-readable medium of claim 12, wherein the installation script is in Extensible Markup Language (XML) format.

15. A system for installing a software product using a single executable installation file that includes an installation script and a plurality of program files, the system comprising:
a memory storage;
a processing unit coupled to the memory storage, wherein the processing unit is operative to execute the installation script that is configured to:
detect a system parameter associated with a user computing device;
prompt a dialog to receive a user input for a script parameter;
validate the user input; and
perform a sequence of predefined actions associated with installation operations based on the detected system parameter and the user input.

16. The system of claim 15, wherein the installation script is further configured to:
detect an existing software product component, if the installation is for an update;
determine whether the existing component is eligible for the update; and
determine a sequence of update installations, if multiple updates are available for the existing software component.

17. The system of claim 15, wherein the installation script is further configured to:
upon determining an expiration of a predefined deadline, direct the user to a downloading resource for downloading a current component of the software product.

18. The system of claim 15, wherein the installation script is further configured to:
activate a plug-in module for performing custom installation actions; and
exchange at least one installation parameter with the plug-in module for coordinating the custom installation actions performed by the plug-in with a flow of actions defined within the installation script.

19. The system of claim 15, wherein the system and the user computing device are the same.

20. The system of claim 15, wherein the installation script is further configured to verify a licensing eligibility of the user for the software product.
